(19) United States
(12) Patent Application Publication
(10) Pub. No.: US 2007/0101328 A1
(43) Pub. Date: May 3, 2007

(54) Sequencing a single task sequence across multiple operating environments

(75) Inventors: Anthony Baron, Woodinville, WA (US); Daniel N.J. Drew, Valencia, CA (US); Michael Kelley, Redmond, WA (US); Alex Armanasu, Redmond, WA (US); Bryce Carman, Redmond, WA (US); Brett D.A. Flegg, Redmond, WA (US); Shantanu Sardesai, Sammamish, WA (US); Huajun Luo, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/263,543

(22) Filed: Oct. 31, 2005

(51) Int. Cl. G06F 9/46

(52) U.S. Cl. 718/100

(57) ABSTRACT

Techniques for preserving state information across multiple operating environments on a machine are provided. A task engine creates and utilizes a task environment to preserve state information through multiple operating environments while sequencing the actions in a task sequence. During task sequence execution, the task environment is maintained in the machine's memory. If an action that is being executed involves initiating a reboot operation, the task environment in memory is saved to disk (i.e., non-volatile memory). When the machine completes the reboot operation, either into the same operating environment or a new operating environment, the task engine creates a new task environment in the machine's memory, and the new task environment is restored from the previously saved task environment on disk. The task engine then continues to sequence the actions in the task sequence utilizing the new task environment in memory.

### BACKGROUND

It is not uncommon for an organization to have hundreds, if not thousands of computer systems. These computer systems typically operate under the control of software, commonly referred to as an operating system. Within these organizations, the operating system is installed on the computer systems by system administrators.

Deployment of an operating system on a computer system is time consuming and involves performing a complex sequence of activities. The activities typically include: preparing the computer system for deployment; capturing the user state prior to the deployment (i.e., rebuild of the system); reformatting the hard drive; installing the desired (e.g., new) version of the operating system; and completing the restoration of the previously saved user state to the computer system. For example, one way that operating system deployment can occur within an organization is to have a system administrator physically visit each of the computer systems in the organization and manually perform the activities necessary to deploy the desired operating system. Manually performing these complex activities is extremely expensive in terms of time and human resources, and often results in mistakes or inconsistencies during the deployment process. This is further compounded as the number of computer systems on which operating systems are being deployed increases.

Moreover, configuration of the computer system requires that the sequence of activities that are being executed must be able to run when the computer system is in a number of different configuration states during the operating system deployment. The typical configuration states are: (1) the computer system is running a previous operating system that is being replaced and needs to perform preparatory activities (also referred to as being in an old operating system state); (2) the computer system has no operating system present or is running a minimal operating system and is about to install a new operating system (also referred to as being in a pre-installation state); and (3) the new operating system has been installed on the computer system and a number of post-operating system tasks need to be performed, such as installing additional applications or performing some specific configuration (also referred to as being in a new operating system state). Scripting operating system deployments across the various computer system states present significant challenges that traditional scripting or sequencing mechanisms do not solve.

### SUMMARY

Techniques for preserving state information across multiple operating environments on a machine are provided. A task engine creates and utilizes a task environment to preserve state information through multiple operating environments while sequencing the actions in a task sequence. During task sequence execution, the task environment is maintained in the machine's memory. If an action that is being executed involves initiating a reboot operation, the task environment in memory is saved to disk (i.e., non-volatile memory). When the machine completes the reboot operation, either into the same operating environment or a new operating environment, the task engine creates a new task environment in the machine's memory, and the new task environment is restored from the previously saved task environment on disk. The task engine then continues to sequence the actions in the task sequence utilizing the new task environment in memory.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level block diagram illustrating an example environment in which a task sequence deployment system may operate.

FIG. 2 is a block diagram that illustrates the execution of a task sequence on a target machine over time, according to some embodiments.

FIG. 3 is a block diagram that illustrates selected components of a task environment, according to some embodiments.

FIG. 4 is a block diagram that illustrates example variable scopes, according to some embodiments.

FIG. 5 is a flow diagram that illustrates the processing of a task engine in sequencing a task sequence, according to some embodiments.

FIG. 6 is a flow diagram that illustrates the processing of a task engine to retrieve machine-specific information, according to some embodiments.

FIG. 7 is a flow diagram that illustrates the processing of a task engine to create a variable scoping mechanism, according to some embodiments.

FIG. 8 is a flow diagram that illustrates the reading of a variable using the variable scoping mechanism, according to some embodiments.

### DETAILED DESCRIPTION

Various techniques for preserving state information through multiple phases of an operating system (OS) deployment on a computer system (also referred to herein as a “machine”), are provided. In some embodiments, when executing a task sequence, a task engine creates and utilizes a task environment to sequence the task sequence across multiple phases and/or operating environments of an OS deployment on a machine. The task sequence is an ordered sequence of activities (also referred to herein as “actions”), such as, by way of example, capture user state, restore user state, re-partition a hard drive, reformat a hard drive, shut down the OS, install an OS, run or execute a program or script, and other well-known activities, that may be performed on the machine. The task environment is a set of variable name-value pairs that is preserved across process boundaries, reboots, OSs, etc., and is used by the task engine and the actions in the task sequence to store machine configuration and state information during execution of the task sequence.

In some embodiments, the task environment is implemented as a COM interface. The task environment provides the task engine and the actions in the task sequence the ability to persist data across multiple operating environments on the machine (e.g., across multiple reboots of the machine, multiple OSs on the machine, etc.), access values specific to the machine, and deal with multiple variable scopes on the machine by utilizing the COM interface provided by the task environment. Variable scopes are further discussed below.

By way of an example scenario, when the task engine first launches a task sequence, the task engine creates a task environment in the machine's memory, for example, in a shared memory block. The task engine then populates the task environment with machine and collection variables. As used herein, a machine variable generally refers to a characteristic that is specific to a particular machine (e.g., the name of a machine), and a collection variable generally refers to a characteristic that is specific to a group or collection of machines to which the particular machine belongs (e.g., the department to which the machine belongs). The task sequence then executes the actions in the task sequence according to their sequence. As the task sequence executes, each action may read and/or write variables in the task environment. For example, each action can read and write variables in the task environment using the COM interface provided by the task environment. The variables that are written by the actions during the execution of the task sequence are deemed to be of run-time scope. If an action initiates a reboot operation on the machine, the task engine encrypts the task environment's run-time scope, and saves the encrypted run-time scope in non-volatile memory, such as the machine's hard disk. When the machine completes the reboot (e.g., either into the same OS, into a pre-installation environment, or a new OS), the task engine creates a new task environment in memory and restores the task environment from non-volatile memory (e.g., the task engine restores the task environment's run-time scope that was previously saved to disk prior to the reboot). The task engine then resumes execution of the task sequence with the next action that needs to be executed. In another embodiment, the task engine may download the machine and collection variables from a remote location, such as, by way of example, a management server, at the start of the task sequence and cache the variables on the machine's disk with the rest of the information. The pre-installation environment exists when an image (e.g., minimal OS image) has been applied to the target machine, but before the target machine has been rebooted into the OS contained in the image. In some embodiments, the task engine executes each action in the task sequence as a separate process on the machine. In some embodiments, the task engine saves the task environment in non-volatile memory after every action in the task sequence. One technical benefit to saving the task environment after every action is that the task sequence can be restored in case of an unexpected event (e.g., power failure).

In some embodiments, deploying the task sequence using a software distribution infrastructure, such as that provided by MICROSOFT's System Management Server (SMS), allows a single task sequence to be run simultaneously on multiple machines. SMS provides an infrastructure for managing large groups of WINDOWS-based machines. SMS provides administrators the ability to manage the machines on a network, distribute software to the machines from a central location, detect the machines on the network, track software and hardware configurations, and perform other tasks on the machines from a remote location. In particular, SMS provides administrators the ability to maintain machine-specific information in a central database. The information may have varying scopes. For example, the information may be specific to the machine, specific to a collection in which the machine belongs, specific to a site in which the machine is situated, etc. The administrator can then assign each machine an SMS management server, also referred to as a management point, which may be utilized by the machine to access the machine-specific information. When a single task sequence is deployed on multiple machines, while the general execution flow of the task sequence is the same on each of the machines, specific information is needed on each machine on an individual machine and group (e.g., collection, site, etc.) level. For example, when deploying an OS, each machine may require a unique product key (this is machine level information), and a collection of machines may join a common domain (this is collection level information). When the task engine launches the task sequence, the task engine sends its management server a request for the variables that apply to the machine. These variables are the machine level information, collection level information, site level information, and any other appropriate machine-specific information that is maintained by the management server. Upon receiving the request, the management server queries the database and sends back a response with all of the variables that apply to the machine. The task engine then creates the task environment in memory and populates the task environment with the received information (e.g., machine and collection variables). The task engine may also restore the previous task environment (e.g., the run-time variables) that may have been saved in non-volatile memory. The task engine does not restore the previous task environment when the task sequence is first launched since there is no previous task environment to restore when the task sequence is first launched. Retrieving machine-specific information in this manner allows each action of the single task sequence executing on each of the multiple machines to have access to variable values (e.g., information) specific to the particular machine on which the action is executing. In some embodiments, the request and responses sent between the task engine and the management server may first be encrypted (i.e., the task engine sends its management server an encrypted request for the variables that apply to the machine, and the management server sends back an encrypted response with all of the variables that apply to the machine).

The SMS infrastructure constitutes but one suitable paradigm with which a single task sequence may be deployed to multiple machines. One skilled in the art will appreciate that other paradigms provided by any of a variety of well-known software configuration and release management systems may be utilized to deploy the task sequence to multiple machines.

In some embodiments, the task engine maintains the variables in the task environment according to the variable's scope. For example, the task engine may define a shared memory block per variable scope. Then, when the task engine starts a task sequence, the task engine populates the variable scopes, such as the machine scope, collection scope, site scope, etc., using the variables obtained from the management server, and creates an empty run-time scope. When each action is run, the task engine creates a default scope and initializes the default scope from data defined in the task sequence. The variables in the default scope are defined in the task sequence itself. For example, an administrator who writes or develops the task sequence can define the default scope variables. When an action writes a variable while executing, the action writes the variable into the run-time scope. When the action completes, the task engine destroys the default scope. Then, when an action reads a variable from the task environment, the action first looks in the run-time scope to see if the variable is defined in the run-time scope (i.e., is the variable a run-time variable?). If the variable is defined in the run-time scope, then the action reads the variable from the run-time scope. Otherwise, if the variable is not found in the run-time scope, the action looks in the machine scope (i.e., is the variable specific to the machine?). If the variable is defined in the machine scope, then the action reads the variable from the machine scope. Otherwise, if the variable is not found in the machine scope, the action looks in the collection scope (i.e., is the variable specific to the collection of machines to which the machine belongs?). If the variable is defined in the collection scope, then the action reads the variable from the collection scope. In a similar manner, the action sequentially looks in the other intermediate scopes (e.g., site scope) to see if the variable is defined in the particular intermediate scope. If the variable is not found in any of the intermediate scopes (e.g., machine scope, collection scope, site scope), the action looks in the default scope (i.e., is the variable a default variable that is defined in the task sequence?). If the variable is found in the default scope, then the action reads the variable from the default scope. In the unlikely event that the variable is not defined in the default scope, the action may generate an error report. One skilled in the art will appreciate that the intermediate scopes may be checked in a different sequence than the sequence described above.

A technical advantage to the scoping mechanism described above is that it allows each action to have predefined default variable values that can be overwritten at any (e.g., one or more) of the other variable scopes. For example, a typical task sequence may have multiple reboot actions, and each reboot action may have associated with it a warning message and a countdown time. The countdown time value may be set in the task sequence, thus making the countdown time variable a default scope. The warning message allows users of the machine to save their work before the machine is rebooted. However, if an administrator wants to run the same task sequence on the collection of machines in building 44, floor 3, over the weekend when the administrator knows that nobody will be working on these machines, the administrator can simply set the countdown time value to zero (0) seconds in a collection scope (e.g., collection of machines in building 44, floor 3). Then, when the task sequence is run on the machines in building 44, floor 3, the countdown time value of zero is read or populated into the collection scope on each machine, causing the reboot countdown messages to be skipped on each of the machines.

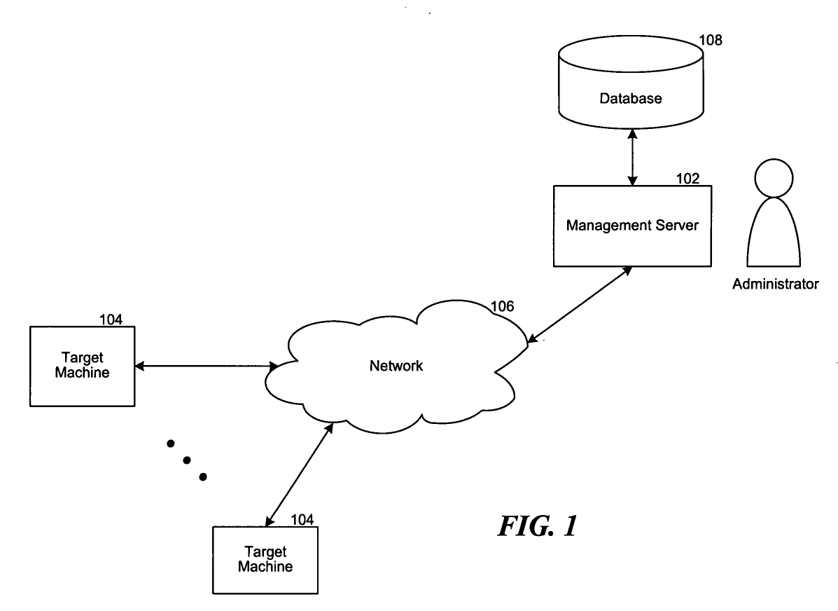

FIG. 1 is a high-level block diagram illustrating an example environment in which a task sequence deployment system may operate. The operating environment is only one example of a suitable operating environment and is not intended to suggest any limitation as to the scope of use or functionality of the task sequence deployment system. As depicted, the environment comprises a management server 102 coupled to one or more target machines 104 through a network 106. The management server is also coupled to a database 108. Only one management server is shown in FIG. 1 for simplicity and one skilled in the art will appreciate that the management server may be comprised of a plurality of servers. As used herein, the terms “connected,” “coupled,” or any variant thereof, means any connection or coupling, either direct or indirect, between two or more elements; the coupling or connection between the elements can be physical, logical, or a combination thereof.

In general terms, the management server facilitates configuration management and release management of the machines. The management server provides a management console with which an administrator can generate a task sequence. In some embodiments, the management console may provide a wizard, a graphical user interface, and/or other suitable editor that provides the administrator the capability to create a task sequence comprised of a sequence of actions of varying degrees of complexity. For example, the wizard may ask the administrator a number of simple questions, and using the responses to the asked questions, the wizard may build a task sequence for the administrator. In another example, the editor may be implemented as a graphical tool that allows the administrator to assemble and modify a task sequence by performing basic “drag-and-drop” operations on a set of pre-built actions. The management server contains a delivery component that facilitates the delivery of the task sequence, as well as other programs and data, including operating system images, to the plurality of machines. The management server may also contain a configuration component that allows the administrator to specify configuration information for the machines. For example, the configuration component may provide an interface through which the administrator can specify machine-specific information (e.g., values for machine scope variables, values for collection scope variables, values for site scope variable, etc.) for each of one or more of the machines. The database maintains the persistent data (e.g., the task sequence, machine-specific information, etc.) that is generated by the management server. In a typical scenario, the administrator uses the management server's administrator console to create a task sequence that is to be run on the plurality of target machines. The task sequence may be the sequence of actions that are performed to deploy a newer version of an OS on each of the machines. The administrator also uses the configuration component of the management server to create policies for the plurality of target machines, where each policy contains the machine-specific information for the respective target machine. The administrator can then use the delivery component of the management server to deploy the task sequence, task engine, as well as any necessary images, on the target machines. For example, a client process that is configured to periodically “pull” content destined or appropriate for the respective machine from the management server may be executing on each of the target machines.

In some embodiments, the task engine is installed on the target machines, and each of the target machines may be configured to start the task engine to execute the task sequence on the machine. For example, the task engine may be installed on each of the target machines as a service, thus causing the task engine to be executed as part of the boot-up process on each of the machines. One skilled in the art will appreciate that the task engine may be invoked outside of the boot-up process. For example, the task engine may be executed in response to a user's request, at a scheduled time or interval, for example, as specified in an applicable policy, by booting from a removable media, by booting from a PXE server, etc.

In general terms, the network is a communications link that facilitates the transfer of electronic content between, for example, the attached target machines and the management server. In some embodiments, the network includes the Internet. It will be appreciated that the network may be comprised of one or more other types of networks, such as a local area network, a wide area network, a point-to-point dial-up connection, and the like.

The computing device on which the task sequence deployment system, including the target machines and management server, is implemented may include a central processing unit, memory, input devices (e.g., keyboard and pointing devices), output devices (e.g., display devices), and storage devices (e.g., disk drives). The memory and storage devices are computer-readable media that may contain instructions that implement the task sequence deployment system. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

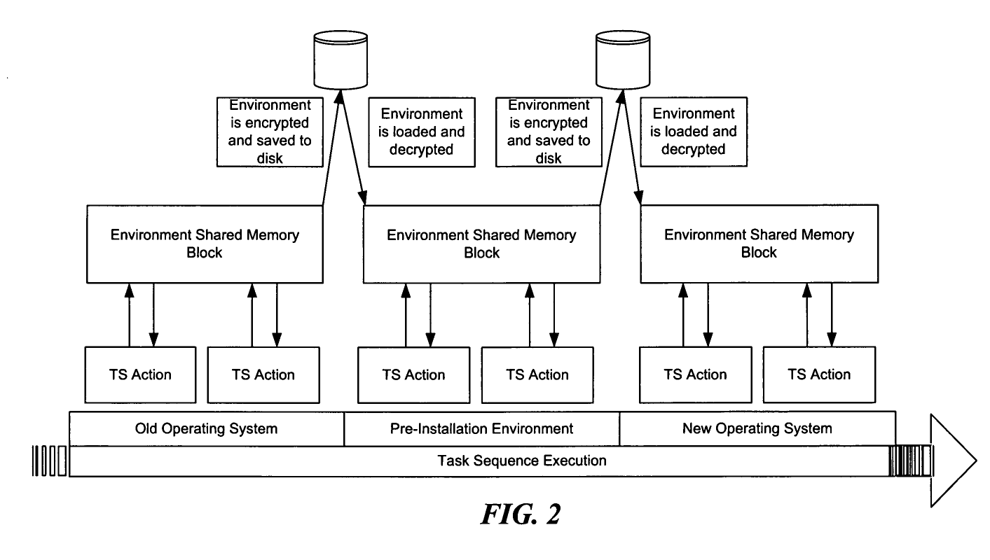

FIG. 2 is a block diagram that illustrates the execution of a task sequence on a target machine over time, according to some embodiments. As depicted, the machine starts out in an old operating system environment (i.e., the machine is executing the old operating system). When the task engine starts executing the task sequence in the old operating system environment, the task engine creates a task environment for the old operating system environment in memory and populates the task environment with the machine-specific information from, for example, the management server. When the task engine sequences each action in the task sequence in the old operating system environment, each action may read and write variables in the task environment. If an action initiates a reboot into a pre-installation environment, the task engine encrypts and saves the run-time variables to disk.

When the machine completes the reboot into the pre-installation environment, the task engine creates a task environment for the pre-installation environment in memory, populates the task environment with the machine-specific information, and decrypts and loads the run-time variables which were previously saved prior to leaving the old operating system environment from disk to the task environment. When the task engine sequences each action in the task sequence in the pre-installation environment, each action may read and write variables in the task environment. If an action initiates a reboot into a new operating system environment, the task engine encrypts and saves the run-time variables to disk.

When the machine completes the reboot into the new operating system environment, the task engine creates a task environment for the new operating system environment in memory, populates the task environment with the machine-specific information, and decrypts and loads the run-time variables which were previously saved prior to leaving the pre-installation environment from disk to the task environment. When the task engine sequences each action in the task sequence in the new operating system environment, each action may read and write variables in the task environment.

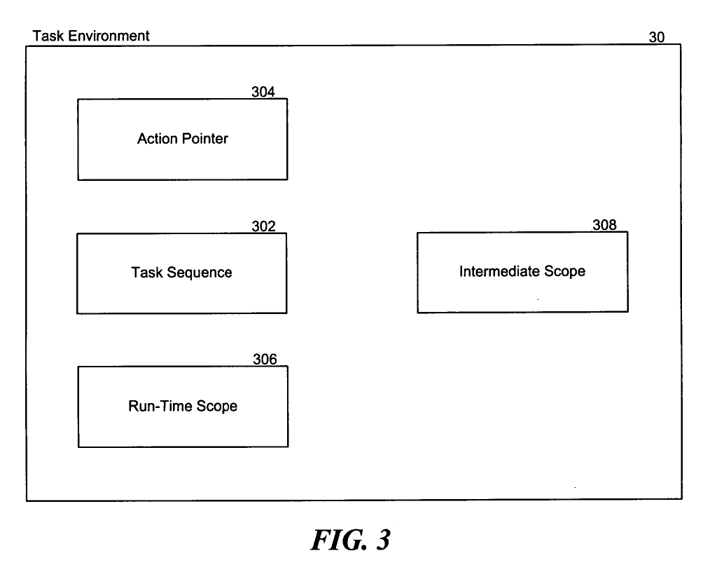

FIG. 3 is a block diagram that illustrates selected components of a task environment, according to some embodiments. As depicted, a task environment 30 comprises a task sequence 302, an action pointer 304, a run-time scope 306, and an intermediate scope 308. The task sequence is a sequence of one or more actions that is to be run. The action pointer is an indication of the current location in the task sequence. The action pointer may identify either the action being run or the next action to be run in the task sequence. The run-time scope is created when a task sequence starts executing and comprises the run-time variables which are created by the actions during the execution of the task sequence. The intermediate scope is created and populated when the task sequence starts executing and comprises the machine-specific variables (e.g., machine level variables, collection level variables, site level variables, etc.). In some embodiments, the intermediate scope is populated with information obtained from the management server.

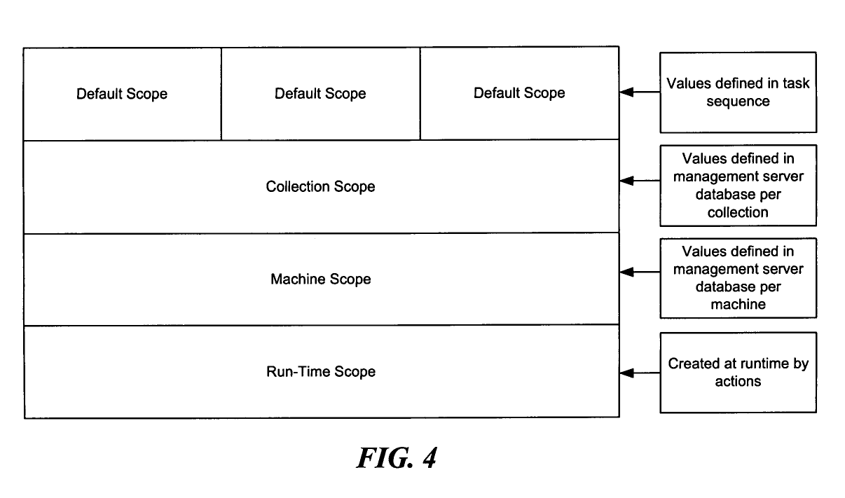

FIG. 4 is a block diagram that illustrates example variable scopes, according to some embodiments. As depicted, the variable scopes comprise a run-time scope, a machine scope, a collection scope, and a plurality of default scopes. The run-time scope, machine scope and collection scope is created when a task sequence starts executing and lasts for the duration of the task sequence execution while the machine is in a particular operating environment. The contents of the run-time scope are created by the actions in the task sequence. The contents of the machine scope are the variables that are specific to the particular machine, and the values are defined in the management server database. The contents of the collection scope are the variables that are specific to a collection of machines to which the particular machine belongs, and the values are defined in the management server database. When each action in the task sequence is run, a default scope for the currently executing action is created and initialized from the data/information defined in the task sequence. When the action completes, the default scope associated with the action is destroyed. Thus, each default scope only lasts for the duration of the corresponding action.

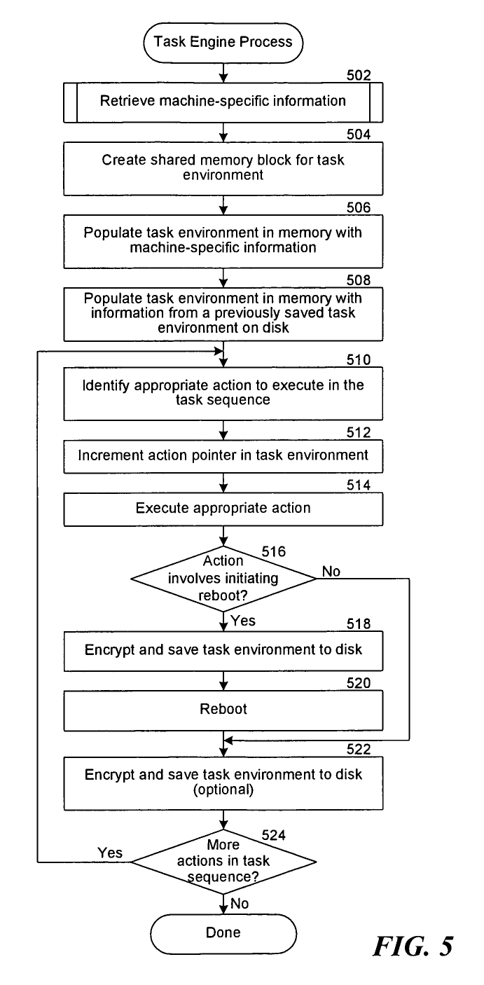

FIG. 5 is a flow diagram that illustrates the processing of a task engine in sequencing a task sequence, according to some embodiments. In block 502, when the task engine starts running on a machine, the task engine retrieves the machine-specific information. In block 504, the task engine creates a shared memory block for a task environment. In block 506, the task engine populates the task environment in memory with the retrieved machine-specific information. In block 508, the task engine populates the task environment in memory with information from a previously saved task environment on disk, if such information exists. In block 510, the task engine identifies an appropriate action (i.e., the current action) to execute in the task sequence. In block 512, the task engine increments the action pointer maintained in the task environment to identify the next action that is to be executed in the task sequence. In block 514, the task engine executes the current action. In block 516, the task engine checks to determine whether the current action involves initiating a reboot operation. If the current action involves initiating a reboot operation, the task engine encrypts and saves the task environment in memory to disk in block 518. In some embodiments, the task engine encrypts and saves the run-time variables (e.g., the variables that are created by the actions), the action pointer, and the task sequence to disk. In some embodiments, the task engine encrypts and saves the entire contents of the task environment in memory to disk. Subsequent to saving the task environment to disk (block 518), the task engine reboots the machine in block 520.

If, in block 516, the task engine determines that the current action does not involve initiating a reboot operation, then, in block 522, the task engine may optionally encrypt and save the task environment in memory to disk. In block 524, the task engine checks to determine whether there are more actions to execute in the task sequence. If there are more actions to execute, then the task engine continues to sequence the actions in the task sequence in block 510. Otherwise, the task engine stops processing. In some embodiments, the task engine may provide diagnostic reports regarding the execution of the task sequence. In some embodiments, the task engine provides an interface with which a user, such as a local administrator, can start, stop, or step through an execution of a task sequence. The task engine interface may also allow the administrator to restart execution of a task sequence from any action or point of execution in the task sequence.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps.

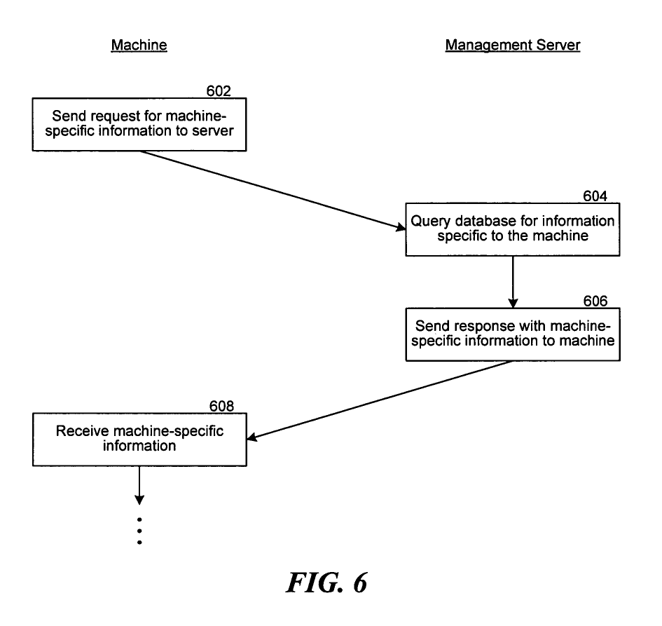

FIG. 6 is a flow diagram that illustrates the processing of a task engine to retrieve machine-specific information, according to some embodiments. In block 602, the task engine executing on a machine sends a request for the machine-specific information to the machine's management server. In block 604, the management server receives the request and queries a database for information specific to the machine. In block 606, the management server sends a response with the machine-specific information to the machine. In block 608, the task engine receives the machine-specific information sent by the management server, and accordingly processes the received information. The task engine may store some or all of the received information, for example, on a local disk, on a local removable media, or enter the information into a local UI.

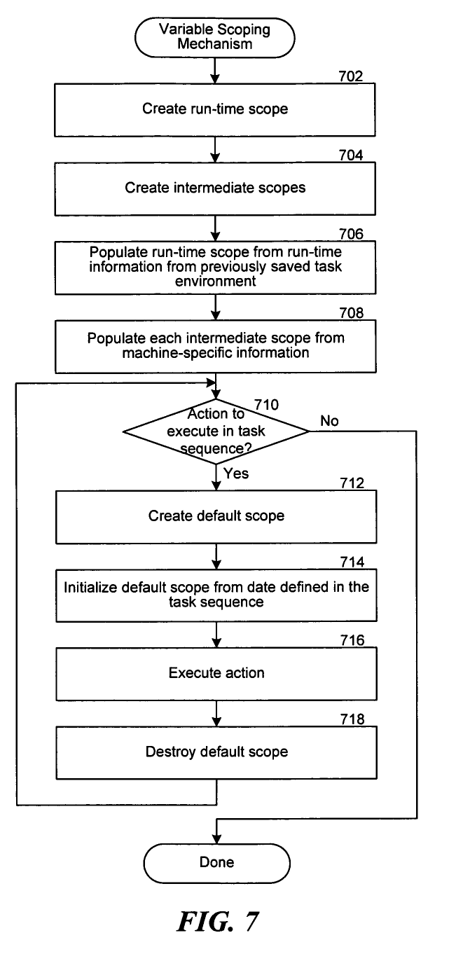

FIG. 7 is a flow diagram that illustrates the processing of a task engine to create a variable scoping mechanism, according to some embodiments. In block 702, when the task engine creates a task environment in memory on a machine, the task engine creates a run-time scope in memory. In block 704, the task engine creates the intermediate scopes in memory. For example, the task engine may create one or more of a machine scope, collection scope, site scope, etc. in memory. In block 706, the task engine populates the run-time scope in memory from run-time information from a previously saved task environment. In block 708, the task engine populates each of the intermediate scopes in memory from the appropriate machine-specific information. In block 710, the task engine checks to determine whether there is an action to execute in the task sequence. If there is an action to execute in the task sequence, in block 712, the task engine creates a default scope in memory. In block 714, the task engine initializes the default scope from data defined in the task sequence. In block 716, the task engine executes the action. Subsequent to executing the action, in block 718, the task engine destroys the default scope that was created in memory for the just-executed action. The task engine then checks to determine whether there is an action to execute in the task sequence in block 710. If the task engine determines that there are no actions in the task sequence to execute, the task engine stops processing. In some embodiments, the task engine destroys the run-time scope and the intermediate scopes that were created in memory upon determining that there are no actions in the task sequence to execute.

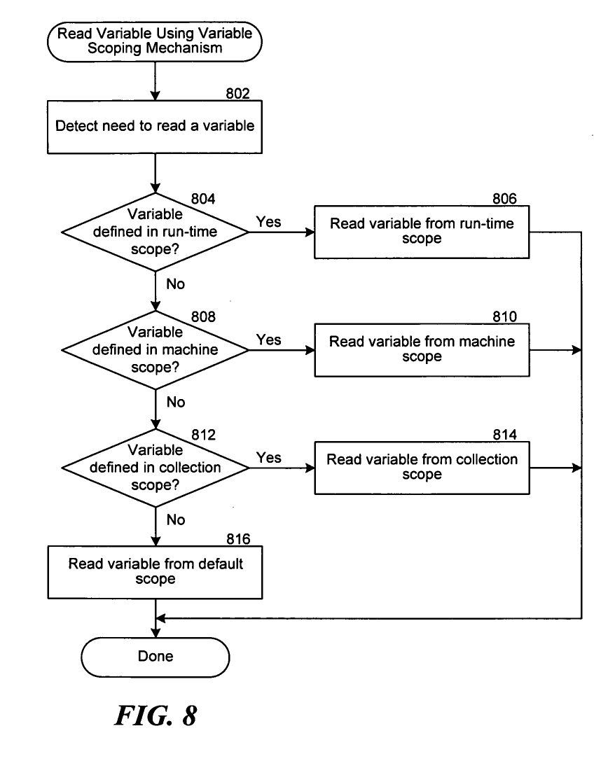

FIG. 8 is a flow diagram that illustrates the reading of a variable using the variable scoping mechanism, according to some embodiments. In block 802, a need to read a variable while executing an action is detected. In block 804, a check is performed to determine if the variable is defined in the run-time scope in the task environment in memory. If the variable is defined in the run-time scope, then, in block 806, the variable is read from the run-time scope. Otherwise, if the variable is not defined in the run-time scope, then, in block 808, a check is performed to determine if the variable is defined in the machine scope in the task environment in memory. If the variable is defined in the machine scope, then, in block 810, the variable is read from the machine scope. Otherwise, if the variable is not defined in the machine scope, then, in block 812, a check is performed to determine if the variable is defined in the collection scope in the task environment in memory. If the variable is defined in the collection scope, then, in block 814, the variable is read from the collection scope. Otherwise, if the variable is not defined in the collection scope, then, in block 816, the variable is read from the default scope in the task environment in memory.

Although the subject matter has been described in language specific to structural features and/or methodological acts, it is to be understood that the subject matter defined in the appended claims is not necessarily limited to the specific features or acts described above. For example, in some embodiments, the task sequence can be run from a full media CD. In some embodiments, the task sequence can run on a bare metal machine initiated by a boot media CD or PXE. In some embodiments, the task sequence can run generic actions other than or in addition to actions that deploy an OS. In some embodiments, the task sequence can contain error handling, grouping, conditionals, and/or loops. Accordingly, the specific features and acts described above are disclosed as example forms of implementing the claims.

I/We claim:

1. A method in a computer system for sequencing a task sequence across multiple operating environments of the computer system, the method comprising:
creating a task environment in memory from a previously saved task environment on disk, the task environment comprising information regarding the computer system;
determining an appropriate action to perform in a task sequence, the task sequence comprising a sequence of at least one action;
indicating the performance of the appropriate action in the task environment;
determining whether the appropriate action involves initiating a reboot of the computer system;
upon determining that the appropriate action involves initiating a reboot of the computer system, saving the task environment in memory to disk; and
executing the appropriate action.

2. The method of claim 1, wherein the sequencing of the task sequence occurs during a reboot of the computer system into a prior operating system environment.

3. The method of claim 1, wherein the sequencing of the task sequence occurs during a reboot of the computer system into a pre-installation environment.

4. The method of claim 1, wherein the sequencing of the task sequence occurs during a reboot of the computer system into a new operating system environment.

5. The method of claim 1 further comprising encrypting the task environment prior to saving the task environment in memory to disk.

6. The method of claim 1, further comprising, subsequent to executing the appropriate action, encrypting the task environment in memory and saving the encrypted task environment to disk.

7. The method of claim 1, wherein the information in the task environment is maintained as a set of name-value pairs.

8. The method of claim 1, wherein the information comprises computer system state information.

9. The method of claim 1, wherein the task sequence is maintained in the task environment.

10. The method of claim 1, wherein the appropriate action is executed as an independent process.

11. The method of claim 1 further comprising:
determining an appropriate action to perform in the task sequence,
obtaining computer system-specific information from a remote location; and
populating the task environment in memory with the computer system-specific information.

12. The method of claim 11, wherein the remote location is a remote management server.

13. The method of claim 1, wherein executing the action comprises writing a variable into the task environment in memory.

14. The method of claim 13, wherein the variable is written as a run-time variable in a run-time scope.

15. A method in a computer system for scoping variables while sequencing a task sequence, the method comprising:
upon execution of a task sequence comprising a sequence of at least one action,
creating a run-time scope for run-time variables, the run-time variables being the variables created by the task sequence execution;
creating a machine scope for machine variables, the machine variables being the variables that are specific to the computer system;
creating a collection scope for collection variables, the collection variables being the variables that are specific to a collection of machines to which the computer system belongs;
populating the machine scope and the collection scope from computer system-specific data; and
upon determining that there is an action to perform in the task sequence,
creating a default scope for default variables;
initializing the default scope from data defined in the task sequence;
executing the action; and
upon completion of the action, destroying the default scope.

16. The method of claim 15, wherein the computer system-specific data is obtained from a management server.

17. The method of claim 15, wherein executing the action comprises writing a variable into the global scope.

18. The method of claim 15, wherein each of the scopes are created in a respective shared memory block.

19. The method of claim 15 further comprising creating a site scope for site variables, the site variables being the variables that are specific to a site in which the computer system belongs.

20. A method in a computer system for reading a variable, the method comprising:
upon determining that a variable is defined in a run-time scope, reading the variable from the run-time scope;
upon determining that a variable is not defined in the run-time scope,
upon determining that the variable is defined in an intermediate scope, reading the variable from the intermediate scope;
upon determining that the variable is not defined in the intermediate scope, reading the variable from a default scope.
